(19) United States
(12) Patent Application Publication
(10) Pub. No.: US 2016/0202495 A1
(43) Pub. Date: Jul. 14, 2016

(54) Optical System and Image Pickup Apparatus

(71) Applicant: Tamron Co., Ltd., Saitama-shi (JP)

(72) Inventors: Shoichiro Hirakawa, Saitama-shi (JP); Shingo Abe, Saitama-shi (JP)

(21) Appl. No.: 14/990,146

(22) Filed: Jan. 7, 2016

(30) Foreign Application Priority Data
Jan. 8, 2015 (JP) 2015-002353

(51) Int. Cl. G02B 27/64; G02B 15/14; H04N 5/232

(52) U.S. Cl. CPC G02B 27/646; H04N 5/23287; G02B 15/14

(57) ABSTRACT

An optical system including: a first movement group moving along an optical axis direction at the time of focusing from an object at infinity to a short-distance object; and a second movement group provided on an image side of the first movement group and moving to an object side by an amount of movement different from an amount of movement of the first movement group at the time of focusing from the object at infinity to the short-distance object. The optical system further includes an image stabilization group.

### CROSS-REFERENCE TO RELATED APPLICATION

This application claims priority to Japanese Patent Application No. 2015-002353 filed Jan. 8, 2015, the disclosure of which is hereby incorporated in its entirety by reference.

### BACKGROUND OF THE INVENTION

1. Field of the Invention

The present invention relates to an optical system and an image pickup apparatus, and in particular to an optical system equipped with an image stabilization function for reducing image blurring due to vibration such as hand shake at the time of imaging and an image pickup apparatus.

2. Description of the Related Art

Conventionally, various focusing systems have been proposed for an imaging lens. For example, the focusing systems are classified into a whole feeding system, a front group feeding system, an inner focusing system and the like according to arrangement of movement groups that move at the time of focusing. Many of imaging lenses of these kinds of systems adopt focusing by a single movement group. Therefore, it is difficult to suppress variation in aberration at the time of focusing, and it is difficult to increase close-distance magnification while maintaining high image formation performance in the entire focus area.

In comparison, a focusing system called a floating system is known in which, at the time of focusing, multiple movement groups are moved by different amounts of movement, respectively (see, for example, Japanese Patent Laid-Open No. 2003-121735). In such a floating system, it is possible to suppress variation in aberration at the time of focusing. Therefore, it is possible to excellently perform aberration correction even in an optical system with a high close-distance magnification irrespective of focusing distance, from an infinite distance to a close-distance, and maintain the image formation performance high in the entire focus region.

Further, a demand for an imaging lens equipped with an image stabilization function (a hand-shake compensation function) has been increasing recently with increase in pixel density of image sensors. An optical system is known which is equipped with an image stabilization function for, in order to correct an image position displaced by vibration such as hand shake, moving a part of lenses in an optical system as an image stabilization group in a direction vertical to an optical axis to displace an image forming position (see, for example, Japanese Patent Laid-Open No. 2013-231941).

In general, there is a large generation amount of aberration due to decentering of lenses in an optical system with a high close-distance magnification. Especially, the generation amount of decentering coma aberration and decentering image distortion tends to be large. In the optical system equipped with an image stabilization function, the image stabilization group is moved (caused to be decentering) to displace the image forming position. Therefore, at the time of image stabilization, deterioration of the image formation performance due to decentering may increase, exceeding the effect of correcting change in the image position due to vibration. Therefore, in the optical system described in Japanese Patent Laid-Open No. 2013-231941, high image stabilization performance is achieved by configuring the image stabilization group by two or more lens components and suppressing variation in aberration which occurs at the time of causing the image stabilization group to be decentering.

In the optical system described in Japanese Patent Laid-Open No. 2013-231941, however, a rear focusing system is adopted, and the entire image-side lens group is used as a focus group and also used as an image stabilization group. The image-side lens group is configured with multiple lens components, and the diameter of each lens component is relatively large. Therefore, if the entire image-side lens group is used as an image stabilization group, the image stabilization group is heavy, and an image stabilization driving mechanism is also large. Thus, it is difficult to achieve reduction in size and weight of the entire optical system. Further, if the image stabilization group is configured with multiple lens components, there is a problem that the image formation performance easily deteriorates due to a manufacturing error factor which occurs in each lens component. Further, in the optical system described in Japanese Patent Laid-Open No. 2013-231941, focusing is performed by the rear focusing system, and it is difficult to, when the close-distance magnification is set high, achieve high image formation performance in the entire focusing region.

An object of the present invention is to achieve reduction in weight and size of the entire optical system equipped with an image stabilization group and provide the optical system which is excellent in image formation performance, from an infinite distance to a close distance, even at the time of image stabilization.

### SUMMARY OF THE INVENTION

As a result of diligent study, the inventor et al. achieved the above object by adopting the following optical system.

An optical system according to the present invention includes: a first movement group moving along an optical axis direction at the time of focusing from an object at infinity to a short-distance object; and a second movement group provided on an image side of the first movement group and moving to an object side by an amount of movement different from an amount of movement of the first movement group at the time of focusing from the object at infinity to the short-distance object; the optical system further including an image stabilization group in a movement group among movement groups including the first movement group and the second movement group; and the optical system satisfying an expression (1) below:

m1/m2<1.0 (1)

wherein m1 indicates the amount of movement of the first movement group from an infinite-distance focused state to a shortest-distance focused state; m2 indicates the amount of movement of the second movement group from the infinite-distance focused state to the shortest-distance focused state; and, as for the amounts of movement, a negative sign is given to movement to the object side, and a positive sign is given to movement to the image plane side.

### BRIEF DESCRIPTION OF THE DRAWINGS

FIG. 1 is a cross-sectional view showing a lens construction example of an optical system (a fixed focus lens) of Example 1 of the present invention;

FIG. 2 shows a spherical aberration diagram, astigmatism diagram and distortion aberration diagram of the optical system of Example 1 at the time of infinite-distance focusing;

FIG. 3 is a cross-sectional view showing a lens construction example of an optical system (a fixed focus lens) of Example 2 of the present invention;

FIG. 4 shows a spherical aberration diagram, astigmatism diagram and distortion aberration diagram of the optical system of Example 2 at the time of infinite-distance focusing;

FIG. 5 is a cross-sectional view showing a lens construction example of an optical system (a fixed focus lens) of Example 3 of the present invention;

FIG. 6 shows a spherical aberration diagram, astigmatism diagram and distortion aberration diagram of the optical system of Example 3 at the time of infinite-distance focusing;

FIG. 7 is a cross-sectional view showing a lens construction example of an optical system (a fixed focus lens) of Example 4 of the present invention;

FIG. 8 shows a spherical aberration diagram, astigmatism diagram and distortion aberration diagram of the optical system of Example 4 at the time of infinite-distance focusing;

FIG. 9 is a cross-sectional view showing a lens construction example of an optical system (a fixed focus lens) of Example 5 of the present invention;

FIG. 10 shows a spherical aberration diagram, astigmatism diagram and distortion aberration diagram of the optical system of Example 5 at the time of infinite-distance focusing;

FIG. 11 is a cross-sectional view showing a lens construction example of an optical system (a fixed focus lens) of Example 6 of the present invention; and

FIG. 12 shows a spherical aberration diagram, astigmatism diagram and distortion aberration diagram of the optical system of Example 6 at the time of infinite-distance focusing.

### DETAILED DESCRIPTION OF THE PREFERRED EMBODIMENTS

Embodiments of an optical system and an image pickup apparatus according to one embodiment of the present invention will be described below.

### 1. Optical System

### 1-1. Configuration of Optical System

First, a configuration of the optical system according to one embodiment of the present invention will be described. The optical system according to one embodiment of the present invention is characterized in being equipped with a first movement group G1 which moves along an optical axis direction at the time of focusing from an object at infinity to a short-distance object, and a second movement group G2 which is provided on an image side of the first movement group G1 and which moves to an object side by an amount of movement different from an amount of movement of the first movement group G1 at the time of focusing from the object at infinity to the short-distance object; having an image stabilization group Gvc in a movement group among movement groups including the first movement group G1 and the second movement group G2; and satisfying an expression (1) to be described later. Further, it is preferable that the optical system satisfies expressions (2) to (7) to be described later in addition to the expression (1). With regard to the configuration of the optical system, movement groups, a fixed group and an image stabilization groups will be described in that order.

### (1) Movement Groups

The movement groups only have to include the first movement group G1 and the second movement group G2 in that order from the object side. In addition to the first and second movement groups G1 and G2, other lens groups which move along the optical axis direction, such as a third movement group G3, may be included. By adopting a so-called floating system as a focusing system, the optical system according to one embodiment of the present invention can suppress variation in aberration at the time of focusing and can achieve high image formation performance in the entire focus area from an infinite-distance focused state to a shortest-distance focused state even if close-distance magnification is set high. In the case where the movement groups include other lens groups such as the third movement group G3, the amount of movement of the other lens groups only has to be different from the amount of movement of at least one of the first and second movement groups G1 and G2.

A specific lens construction of each of lens groups including the first and second movement groups G1 and G2, which constitute the movement groups, is not especially limited as far as the expression (1) to be described later is satisfied, and a suitable configuration can be appropriately adopted according to optical performance required for the optical system. For example, if the object-side surface of a lens arranged on the most object side in the first movement group G1 is in a shape convex on the object side, correction of astigmatism and coma aberration can be performed more excellently.

Further, it is only required that the second movement group G2 moves to the object side at the time of focusing from an object at infinity to a short-distance object, and the direction of movement of the first movement group G1 is not especially limited. It is more preferable, however, to move the first movement group G1 also to the object side at the time of the focusing similarly to the second movement group G2. By moving the second movement group G2 to the object side, it is possible to reduce change in the angle of light beams incident on the second movement group G2 during transition from the infinite-distance state to the shortest-distance state. At this time, by moving the first movement group G1 to the object side, the height of light beams incident on the first movement group G1 can be suppressed. Therefore, it is possible to excellently correct coma aberration and astigmatism and suppress variation in aberration in the entire focus area from the infinite-distance focused state to the shortest-distance focused state. Therefore, even when the close-distance magnification is set high, it is possible to achieve higher image formation performance in the entire focus area from the infinite-distance focused state to the shortest-distance focused state. When the movement groups includes other lens groups such as the third movement group G3, movement directions of these other lens groups are not especially limited. The lens groups may move to the object side or may move to the image side.

### (2) Fixed Group

The optical system according to one embodiment of the present invention may be equipped with a fixed group in addition to the movement groups described above. Note that it is assumed that the fixed group refers to such a lens group that its position on the optical axis is fixed at the time of focusing. Arrangement of the fixed group is not especially limited. The fixed group may be arranged on the most object side of the optical system, among the movement groups, or on the most image side of the optical system. Arrangement among the movement groups means arrangement between any two adjoining lens groups among the multiple lens groups constituting the movement groups, such as between the first movement group G1 and the second movement group G2. From a viewpoint of reducing the size of the entire optical system as well as obtaining excellent image formation performance, however, it is more favorable to, in the case of arranging a fixed group, arrange the fixed group on the most object side of the optical system. Further, as for a specific lens construction of the fixed group, and the like, a suitable configuration can be appropriately adopted according to optical performance and the like required for the optical system.

### (3) Image Stabilization Group Gvc

In the optical system according to one embodiment of the present invention, the image stabilization group Gvc is provided in a movement group as described above. Note that, that the image stabilization group Gvc is provided in a movement group means not that all lens components constituting the movement group form the image stabilization group Gvc but that a part of the lens components form the image stabilization group Gvc. For example, any one of two or more lens groups constituting a movement group may be caused to be the image stabilization group Gvc. If there are multiple lens components constituting the any one lens group, a part of the lens components may form the image stabilization group Gvc. By arranging the image stabilization group Gvc in a movement group, it is possible to achieve reduction in weight and size of the lens components constituting the image stabilization group Gvc and achieve reduction in weight and size of a driving mechanism for driving the image stabilization group Gvc, in comparison with the case of causing the entire movement group to be the image stabilization group Gvc.

Further, in comparison with the case of arranging the image stabilization group Gvc in the fixed group, that is, in the case of using a part of lens components constituting the fixed group as the image stabilization group Gvc, the size of a lens barrel can be reduced. This is because of the following reason. In the case of adopting the floating system as a focusing system as well as adopting the configuration in which the optical system is equipped with a fixed group together with movement groups, it is conceivable to arrange the fixed group on the most object side, on the most image side or among the movement groups in the optical system as described above. Lenses constituting the fixed group arranged on the most object side of the optical system have the largest diameter among lenses constituting the optical system. Therefore, if the image stabilization group Gvc is arranged in the fixed group arranged on the most object side, the lens diameter of lenses constituting the image stabilization group Gvc is large, and the weight and size of the image stabilization group Gvc cannot be sufficiently reduced. As a result, it becomes difficult to achieve reduction in weight and size of the driving mechanism, and the diameter of the lens barrel also increases.

Further, if the image stabilization group Gvc is arranged in the fixed group arranged among the movement groups, it becomes easier to achieve reduction in weight and size of the image stabilization group Gvc in comparison with the case of arranging the image stabilization group Gvc in the fixed group arranged on the most object side of the optical system. However, it is necessary to provide a floating mechanism for moving each of lens groups constituting the movement groups such as the first movement group G1 and the second movement group G2 along the optical axis, together with the image stabilization driving mechanism described above. Therefore, if the image stabilization group Gvc is arranged in the fixed group arranged among the movement groups, it is necessary to provide the image stabilization driving mechanism arranged around the fixed group in the lens barrel, and provide the floating mechanism across the image stabilization driving mechanism. Therefore, it becomes difficult to achieve reduction in size of the floating mechanism, and, as a result, the diameter of the lens barrel also increases.

If the image stabilization group Gvc is arranged in the fixed group arranged on the most image side of the optical system, the following problem occurs. In general, on the image side of an optical system in a lens barrel, a control board for controlling operations of the optical system, such as operations of the image stabilization driving mechanism and operations of the floating mechanism, is arranged. Therefore, there is a possibility that interference between the image stabilization driving mechanism and the control board occurs in the lens barrel. In order to avoid this, it is necessary to extend the overall optical length. Therefore, if the image stabilization group Gvc is arranged in the fixed group arranged on the most image side, it becomes difficult to achieve reduction in size of the optical system in its full length direction. From these, in comparison with the case of arranging the image stabilization group Gvc in the fixed group, it is possible to achieve reduction in size of the lens barrel in diameter and longitudinal directions and achieve reduction in weight and size of the image stabilization driving mechanism and/or the floating mechanism, and, therefore, it is possible to achieve reduction in weight and size of the entire lens barrel equipped with the optical system by arranging the image stabilization group Gvc in a movement group.

Note that, though the image stabilization group Gvc may be arranged in any lens group, such as the first movement group G1 and the second movement group G2, as far as the lens group is a movement group, it is preferable to arrange the image stabilization group Gvc in a lens group other than a lens group arranged on the most image side, and it is more preferable to arrange the image stabilization group Gvc in the first movement group G1. For example, if the image stabilization group Gvc is arranged in the second movement group G2 when the second movement group G2 is arranged on the most image side of the optical system, there is a possibility that the image stabilization driving mechanism and the control board interfere with each other similarly to the case where the image stabilization group Gvc is arranged in the fixed group. In comparison, if the image stabilization group Gvc is arranged in the first movement group G1, it is not necessary to consider the interference between the image stabilization driving mechanism and the control board because at least the second movement group G2 exists on the image side of the first movement group G1. Therefore, it is preferable to arrange the image stabilization group Gvc in the first movement group G1 to achieve reduction in size of the lens barrel.

Furthermore, in the optical system according to one embodiment of the present invention, it is preferable that the image stabilization group Gvc is configured with a single lens component. Note that, as the single lens component, a single lens, a cemented lens and a compound lens are included, and it is assumed that the single lens component refers to a lens which does not include an air layer between a surface on the most object side and a surface on the most image side. By configuring the image stabilization group Gvc with a single lens component, it is possible to achieve reduction in weight and size of the image stabilization group Gvc itself, and it is also possible to achieve reduction in weight and size of the image stabilization driving mechanism for driving the image stabilization group Gvc, such as an actuator. Therefore, even if the image stabilization driving mechanism is arranged around the image stabilization group Gvc in the lens barrel, it is possible to suppress increase in the lens barrel diameter. If the image stabilization group Gvc is configured with multiple lens components, the image formation performance easily deteriorates due to a manufacturing error factor which occurs in each lens component. In comparison, by configuring the image stabilization group Gvc by a single lens component, it is possible to prevent the deterioration of the image formation performance due to the manufacturing error factor.

Further, from a view point of being able to obtain more excellent image formation performance, it is preferable to cause a single lens component other than a single lens component arranged on the most object side, among lenses constituting the first movement group G1, to be the image stabilization group Gvc. By causing a single lens component other than the single lens component arranged on the most object side, among the lens components constituting the first movement group G1, to be the image stabilization group Gvc, it becomes easier to suppress variation in aberration at the time of image stabilization in the entire focus area.

### (4) Stop

In the optical system according to one embodiment of the present invention, arrangement of a stop is not especially limited. The arrangement of the stop is not especially limited, and the stop can be arranged at any position, such as in the first movement group G1, in the second movement group G2, in the fixed group or between lens groups. No matter which position in the optical system the stop is arranged at, optical advantages according to one embodiment of the present invention can be obtained. Further, the stop may be fixed relative to the image plane or may be movably configured. For example, it is desirable to arrange the stop between the first movement group G1 and the second movement group G2 and integrally move the first movement group G1 and the stop, from a viewpoint of simplifying the movement mechanism (the floating mechanism) for them. Even if the amount of movement of the stop is different from each of the amount of movement of the first movement group G1 and the amount of movement of the second movement group G2, however, the optical advantages according to one embodiment of the present invention can be obtained.

### 1-2. Expression

Next, each expression will be described. As described above, the optical system is characterized in adopting the configuration described above and satisfying the expression (1) below.

m1/m2<1.0 (1)

wherein m1 indicates the amount of movement of the first movement group from an infinite-distance focused state to a shortest-distance focused state; m2 indicates the amount of movement of the second movement group from the infinite-distance focused state to the shortest-distance focused state; and, as for the amounts of movement, a negative sign is given to movement to the object side, and a positive sign is given to movement to the image plane side.

### 1-2-1. Expression (1)

The above expression (1) is an expression defining a ratio of the amounts of movement of the first movement group G1 and the second movement group G2 from the infinite-distance focused state to the shortest-distance focused state. If the expression (1) is satisfied, the second movement group G2 moves to the object side so that the distance between the first movement group G1 and the second movement group G2 decreases, at the time of focusing from an object at infinity to a short-distance object. Therefore, it is possible to decrease change in the angle of light beams incident on the second movement group G2 from the first movement group G1 during transition from the infinite-distance state to the shortest-distance state. Therefore, it is possible to suppress variation in aberration at the time of focusing. At this time, by moving the first movement group G1 to the object side together with the second movement group G2, the size of a space required for moving the movement groups at the time of focusing can be reduced, which leads to reduction in the size of the optical system.

It is more preferable that the optical system satisfies the expression (1)′ below to obtain these advantages. It is more preferable to satisfy an expression (1)″ below; it is more preferable to satisfy an expression (1)′″ below; and it is the most preferable to satisfy an expression (1)″″ below.

0.20<m1/m2<0.98 (1)′

0.30<m1/m2<0.96 (1)″

0.40<m1/m2<0.94 (1)′″

0.50<m1/m2<0.92 (1)″″

### 1-2-2. Expression (2)

It is preferable that the optical system according to one embodiment of the present invention satisfies an expression (2) below.

0.80<f2/f<10.00 (2)

wherein f2 indicates a focal length of the second movement group, and f indicates a focal length of the entire optical system.

The above expression (2) is an expression defining the focal length of the second movement group G2 relative to the focal length of the entire optical system. By satisfying the expression (2), it is possible to obtain a bright optical system with higher image formation performance and further achieve reduction in size of the optical system. In comparison, when the numerical value of the expression (2) becomes equal to or above an upper limit, that is, when the focal length of the second movement group G2 arranged on the image side increases, the refractive power of the second movement group G2 is weak, and it becomes difficult to obtain a bright optical system. At the same time, since the amount of movement of the second movement group G2 at the time of focusing increases, it becomes difficult to achieve reduction in size of the optical system. On the other hand, when the numerical value of the expression (2) is equal to or below a lower limit, that is, when the focal length of the second movement group G2 decreases, the generation amount of aberration in the second movement group G2 increases, and image distortion deteriorates. In order to prevent the deterioration of image distortion and provide an optical system with high image forming performance, the number of lenses required for aberration correction increases. From these, it becomes difficult to achieve reduction in weight and size of the optical system.

It is more preferable that the optical system satisfies the expression (2)′ below to obtain these advantages. It is more preferable to satisfy an expression (2)″ below; it is more preferable to satisfy an expression (2)″′ below; and it is the most preferable to satisfy an expression (2)″″ below.

0.95<f2/f<8.00 (2)′

1.05<f2/f<6.00 (2)″

1.21<f2/f<5.00 (2)″′

1.23<f2/f<4.00 (2)″″

### 1-2-3. Expression (3)

It is preferable that the optical system according to one embodiment of the present invention satisfies an expression (3) below.

1.10<f1/f<6.50 (3)

wherein f1 indicates a focal length of the first movement group, and f indicates the focal length of the entire optical system.

The above expression (3) is an expression defining the focal length of the first movement group G1 relative to the focal length of the entire optical system. By satisfying the expression (3), it is possible to further achieve reduction in size of the optical system and obtain higher image formation performance. In comparison, when the numerical value of the expression (3) becomes equal to or above an upper limit, that is, when the focal length of the first movement group G1 increases, the amount of movement of the first movement group G1 at the time of focusing increases, and it becomes difficult to achieve reduction in size of the optical system. Further, when the numerical value of the expression (3) becomes equal to or below a lower limit, that is, when the focal length of the first movement group G1 decreases, spherical aberration occurs low, and it becomes difficult to suppress variation in aberration in the entire focus area from the infinite-distance focused state to the shortest-distance focused state.

It is more preferable that the optical system satisfies the expression (3)′ below to obtain these advantages. It is more preferable to satisfy an expression (3)″ below; it is more preferable to satisfy an expression (3)″′ below; and it is the most preferable to satisfy an expression (3)″″ below.

1.12<f1/f<6.00 (3)′

1.14<f1/f<5.50 (3)″

1.16<f1/f<5.00 (3)″′

1.18<f1/f<5.00 (3)″″

### 1-2-4. Expression (4)

It is preferable that the optical system according to one embodiment of the present invention satisfies an expression (4) below.

1.25<|fvc|/f<8.00 (4)

wherein fvc indicates a focal length of the image stabilization group, and f indicates the focal length of the entire optical system.

The above expression (4) is an expression defining the focal length of the image stabilization group Gvc. By satisfying the expression (4), the amount of movement of the image stabilization group Gvc at the time of image stabilization is within an appropriate range, and it is possible to secure high image stabilization performance in the entire focus area and achieve reduction in weight and size of the optical system. Further, when the numerical value of the expression (4) becomes equal to or above an upper limit, that is, when the focal length of the image stabilization group Gvc increases, the appropriate amount of movement is exceeded at the time of image stabilization, and the amount of movement of the image stabilization group Gvc increases. Therefore, it becomes necessary to increase the size of the image stabilization driving mechanism for driving the image stabilization group Gvc. As a result, the external diameter of the lens barrel increases, which is not preferable. Further, when the numerical value of the expression (4) becomes equal to or below a lower limit, that is, the focal length of the image stabilization group Gvc decreases, variation in decentering coma aberration and decentering image distortion accompanying decentering of the image stabilization group Gvc at the time of image stabilization increases, and it becomes difficult to secure high image stabilization performance.

It is more preferable that the optical system satisfies the expression (4)′ below to obtain these advantages. It is more preferable to satisfy an expression (4)″ below; and it is more preferable to satisfy an expression (4)′″ below.

1.45<|fvc|/f<6.00 (4)′

1.45<|fvc|/f<5.50 (4)″

1.65<|fvc|/f<5.00 (4)″′

### 1-2-5. Expression (5)

It is preferable that, in the optical system according to one embodiment of the present invention, an expression (5) below is satisfied.

0.1<|(1−vc)r|<0.7 (5)

wherein vc is a lateral magnification of the image stabilization group at the time of infinite-distance focusing, and r is a combined lateral magnification of a lens arranged on an image side of the image stabilization group at the time of infinite-distance focusing.

The above expression (5) is an expression defining a ratio of displacement of an image position relative to the amount of movement of the image stabilization group Gvc. When the numerical value of the expression (5) becomes equal to or above an upper limit, the image position is significantly displaced even if the amount of movement of the image stabilization group Gvc is small. Therefore, high-accuracy control is required at the time of moving the image stabilization group Gvc. Further, when the numerical value of the expression (5) becomes equal to or below a lower limit, the amount of movement of the image stabilization group Gvc required for causing the image position to be displaced by a specific amount increases, and the size of the image stabilization driving mechanism also increases. Therefore, it becomes difficult to achieve reduction in size of the lens barrel.

### 1-2-6. Expressions (6) and (7)

Whether the refractive power of the movement groups including the first movement group G1 and the second movement group G2 or the fixed group is positive or negative is not especially limited and can be appropriately selected according to optical performance required for the optical system. However, it is preferable that any one of the lens groups constituting the optical system has a positive refractive power, and, it is especially preferable that the first movement group G1 and/or the second movement group G2 has a positive refractive power. It is preferable that the lens group having a positive refractive power has at least one lens which has a positive refractive power satisfying expressions (6) and (7) to be described later.

PgF0.006 (6)

d61.0 (7)

wherein PgF indicates deviation of a partial dispersion ratio from a reference line when a line passing through coordinates of C7 (partial dispersion ratio: 0.5393, d: 60.49) and coordinates of F2 (partial dispersion ratio: 0.5829:d: 36.30) is assumed to be the reference line, the coordinates being indicated by partial dispersion ratio and d; and d is an abbe number on a d-line.

By providing a lens group with a positive refractive power, which has a lens with a positive refractive power satisfying the above expressions, in the optical system, it is possible to excellently correct axial color aberration and chromatic aberration of magnification.

### 2. Image Pickup Apparatus

Next, an image pickup apparatus according to one embodiment of the present invention will be described. The image pickup apparatus according to one embodiment of the present invention is characterized in including the optical system according to one embodiment of the present invention and an image sensor provided on the image side of the optical system, the image sensor converting an optical image formed by the optical system to an electrical signal. Note that the image sensor and the like are not especially limited, and a solid-state image sensor and the like, such as a CCD sensor and a CMOS sensor, can be used. The image pickup apparatus according to one embodiment of the present invention is suitable as an image pickup apparatus using the solid-state image sensor, such as a digital camera and a video camera. Further, of course, the image pickup apparatus may be a lens-fixed type image pickup apparatus in which a lens is fixed to a casing or may be a lens-interchangeable type image pickup apparatus such as a single lens reflex camera and a mirrorless single lens camera.

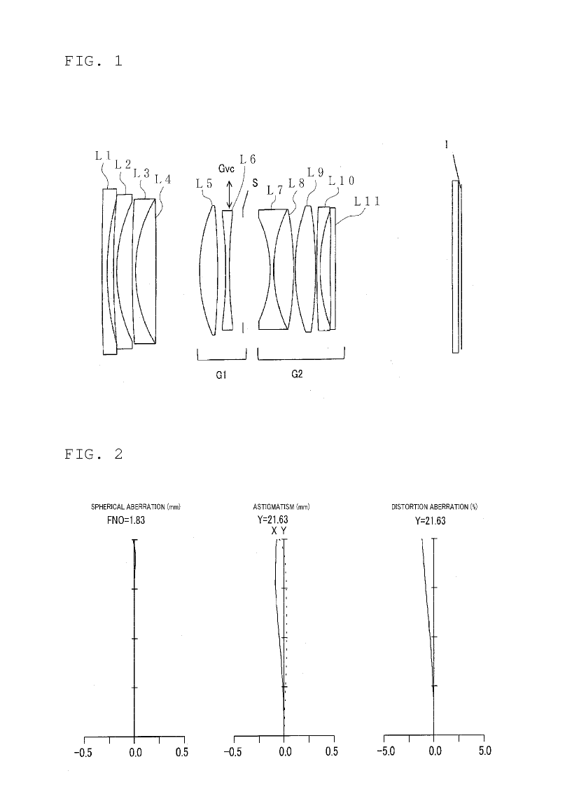

Next, the present invention will be specifically described by showing examples. Note that the present invention is not limited to the examples below. An optical system in each example given below is a shooting optical system used for image pickup apparatuses (optical apparatuses) such as a digital camera, a video camera and a silver halide film camera. In lens cross-sectional views (FIGS. 1, 3, 5, 7, 9 and 11), the left side of the drawings indicates the object side, and the right side indicates the image side.

### Example 1

### (1) Configuration of Optical System

FIG. 1 is a lens cross-sectional view showing a configuration of a fixed focus lens which is an optical system of Example 1 according to the present invention. The fixed focus lens is configured with a fixed group having a negative refractive power, a first movement group G1 having a positive refractive power and a second movement group G2 having a positive refractive power in that order from the object side.

The fixed group is configured with a meniscus lens L1 having a strong radius of curvature on the image side and having a negative refractive power, a meniscus lens L2 having a strong radius of curvature on the image side and having a negative refractive power, and a cemented lens composed of a lens L3 having a negative refractive power and a lens L4 having a positive refractive power, in that order from the object side. The first movement group G1 is configured with a biconvex lens L5 having a positive refractive power and a biconcave lens L6 having aspheric surfaces on both surfaces and having a negative refractive power in that order from the object side. The second movement group G2 is configured with a cemented lens composed of a lens L7 having a negative refractive power and a lens L8 having a positive refractive power, a biconvex lens L9 having a positive refractive power, a meniscus lens L10 having a strong radius of curvature on the image side and having a negative refractive power, and a lens L11 having aspheric surfaces on both surfaces and having a positive refractive power in that order from the object side.

At the time of focusing from an object at infinity to a short-distance object, the fixed group is fixed relative to the image plane, the first movement group G1 moves to the object side, and the second movement group G2 moves to the object side so that the distance between the second movement group G2 and the first movement group G1 decreases. That is, the amount of movement of the second movement group G2 to the object side is larger than the amount of movement of the first movement group G1 to the object side. Further, the biconcave lens L6 constituting the first movement group G1 is an image stabilization group Gvc, and image blurring due to vibration such as hand shake at the time of shooting is corrected by moving the biconcave lens L6 in a direction vertical to the optical axis.

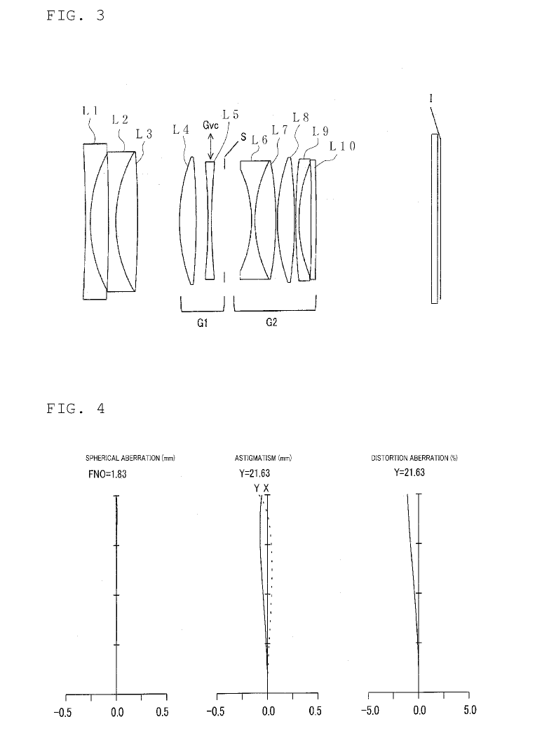

In FIG. 1, “S” shown on the image side of the first movement group G1 indicates an aperture stop. Further, “I” shown on the image side of the second movement group G2 indicates an image plane, specifically an imaging plane of a solid-state image sensor such as a CCD sensor and a CMOS sensor, a film plane of a silver-salt film, or the like. As for these marks and the like, the same goes for FIGS. 3, 5, 7, 9 and 11 shown in Examples 2 to 6.

### (2) Typical Numerical Values

Next, typical numerical values in which specific numerical values of the fixed focus lens are applied will be described. (Table 1-1) shows lens data of the fixed focus lens. In (Table 1-1), “No.” indicates a position number (a surface number) of a lens surface in order from the object side; “R” indicates a curvature of the lens surface; “D” indicates a distance of the lens surface on the optical axis; “Nd” indicates a refractive index relative to a d-line (wavelength=587.6 nm); and “d” indicates an abbe number relative to the d-line (wavelength=587.6 nm). Further, “PgF” has been described above. As for an aperture stop (a stop S), “STOP” is added below the surface number. Further, when a lens surface is aspheric, an asterisk (*) is added next to the surface number, and a paraxial curvature is shown in the column of the curvature R.

(Table 1-2) shows an aspheric coefficient and conic constant of each of aspheric surfaces shown in (Table 1-1) in the case where its shape is indicated by the following expression.

Note that it is assumed that the aspheric surfaces are defined by the following expression:

z=ch²/[1+{1−(1+k)c²h²}^{1/2}]+A4h⁴+A6h⁶+A8h⁸+A10h¹⁰ . . . .

(wherein a curvature (1/r) is indicated by c; a height from the optical axis is indicated by h; a conic coefficient is indicated by k; and the aspheric coefficients of respective orders are indicated by A4, A6, A8, A10 . . . ).

(Table 1-3) shows variable intervals of lens surfaces shown in (Table 1-1) on the optical axis. In (Table 1-3), “INF” means an infinite-distance focused state and “MOD” means a shortest-distance focused state. Further, (Table 1-4) shows the focal length (f), larger aperture ratio (Fno) and half image viewing angle (W) of the fixed focus lens. Further, Table 7 shows numerical values of the expressions (1) to (7). As for the matters related to Table 1, the same goes for Tables 2 to 6 shown in Examples 2 to 6, and, therefore, description of those in Tables 2 to 6 will be omitted below.

FIG. 2 shows longitudinal aberration diagrams at the time of infinite-distance focusing of the fixed focus lens. The longitudinal aberration diagrams show spherical aberration, astigmatism and distortion aberration at the d-line (587.6 nm), respectively, in that order from the left side of the drawing. In the diagram showing astigmatism, a solid line indicates a sagittal direction X, and a broken line indicates a meridional direction Y. Since the order and arrangement of displaying these aberrations, and what are indicated by a solid line, a wavy line and the like in each diagram are similar to those in FIGS. 4, 6, 8, 10 and 12 shown in Examples 2 to 6, description of those in FIGS. 4, 6, 8, 10 and 12 will be omitted below.

TABLE 1-1

| No. | R | D | Nd | νd | ΔPgf |
|---|---|---|---|---|---|
| 1 | 700.00 | 1.70 | 1.49 | 58.06 | |
| 2 | 60.00 | 2.12 | | | |
| 3 | 177.29 | 1.10 | 1.50 | 55.46 | |
| 4 | 36.02 | 5.19 | | | |
| 5 | 270.89 | 1.10 | 1.47 | 66.30 | |
| 6 | 31.53 | 6.82 | 1.78 | 49.62 | |
| 7 | −939.12 | D7 | | | |
| 8 | 36.36 | 0.00 | | | |
| 9 | 36.36 | 6.07 | 1.60 | 65.25 | 0.006 |
| 10 | −149.21 | 2.68 | | | |
| 11* | −90.78 | 1.20 | 1.58 | 48.11 | |
| 12* | 102.07 | 4.47 | | | |
| STOP | INF | D13 | | | |
| 14 | −26.81 | 1.20 | 1.70 | 29.75 | |
| 15 | 30.30 | 6.65 | 1.84 | 42.72 | |
| 16 | −69.08 | 0.50 | | | |
| 17 | 41.52 | 6.83 | 1.84 | 42.72 | |
| 18 | −91.20 | 0.40 | | | |
| 19 | 256.83 | 1.10 | 1.56 | 41.03 | |
| 20 | 37.32 | 3.38 | | | |
| 21* | 206.18 | 1.80 | 1.71 | 51.02 | |
| 22* | −333.64 | D22 | | | |
| 23 | INF | 2.00 | 1.52 | 64.20 | |
| 24 | INF | 1.00 | | | |

### Example 2

### (1) Configuration of Optical System

FIG. 3 is a lens cross-sectional view showing a configuration of a fixed focus lens which is an optical system of Example 2 according to the present invention. The fixed focus lens is configured with a fixed group having a negative refractive power, a first movement group G1 having a positive refractive power and a second movement group G2 having a positive refractive power in that order from the object side.

The fixed group is configured with a biconcave lens L1 having a negative refractive power, and a cemented lens composed of a lens L2 having a negative refractive power and a lens L3 having a positive refractive power in that order from the object side. The first movement group G1 is configured with a biconvex lens L4 having a positive refractive power and a biconcave lens L5 having aspheric surfaces on both surfaces and having a negative refractive power in that order from the object side. The second movement group G2 is configured with a cemented lens composed of a lens L6 having a negative refractive power and a lens L7 having a positive refractive power, a biconvex lens L8 having a positive refractive power, a meniscus lens L9 having a strong curvature on the image side and having a negative refractive power, and a lens L10 having aspheric surfaces on both surfaces and having a positive refractive power in that order from the object side.

At the time of focusing from an object at infinity to a short-distance object, the fixed group is fixed relative to the image plane, the first movement group G1 moves to the object side, and the second movement group G2 moves to the object side so that the distance between the second movement group G2 and the first movement group G1 decreases. Further, the biconcave lens L5 constituting the first movement group G1 is an image stabilization group Gvc, and the biconcave lens L5 moves in a direction vertical to the optical axis at the time of image stabilization.

### (2) Typical Numerical Values

Next, typical numerical values in which specific numerical values of the fixed focus lens are applied will be described. (Table 2-1) shows lens data of the fixed focus lens; (Table 2-2) shows aspheric coefficients and conic constants of aspheric surfaces; (Table 2-3) shows variable intervals of lens surfaces on the optical axis; and (Table 2-4) shows the focal length (f), larger aperture ratio (Fno) and half image viewing angle (W) of the fixed focus lens. FIG. 4 shows longitudinal aberration diagrams of the fixed focus lens at the time of infinite-distance focusing.

TABLE 2-1

| No. | R | D | Nd | νd | ΔPgf |
|---|---|---|---|---|---|
| 1 | −326.35 | 1.70 | 1.52 | 64.15 | |
| 2 | 32.76 | 6.13 | | | |
| 3 | −432.24 | 2.50 | 1.50 | 53.61 | |
| 4 | 31.45 | 7.37 | 1.77 | 49.62 | |
| 5 | −229.08 | D5 | | | |
| 6 | 40.02 | 5.63 | 1.60 | 67.73 | 0.012 |
| 7 | −156.33 | 3.96 | | | |
| 8* | −165.25 | 1.20 | 1.60 | 48.64 | |
| 9* | 96.23 | 436 | | | |
| STOP | INF | D10 | | | |
| 11 | −27.00 | 1.20 | 1.70 | 30.13 | |
| 12 | 28.96 | 7.05 | 1.83 | 42.72 | |
| 13 | −70.31 | 0.50 | | | |
| 14 | 41.18 | 5.77 | 1.83 | 42.72 | |
| 15 | −108.20 | 0.40 | | | |
| 16 | 115.80 | 1.10 | 1.55 | 42.25 | |
| 17 | 32.68 | 4.04 | | | |
| 18* | 350.40 | 1.80 | 1.71 | 51.51 | |
| 19* | −203.43 | D19 | | | |
| 20 | INF | 2.00 | 1.52 | 64.20 | |
| 21 | INF | 1.00 | | | |

### Example 3

### (1) Configuration of Optical System

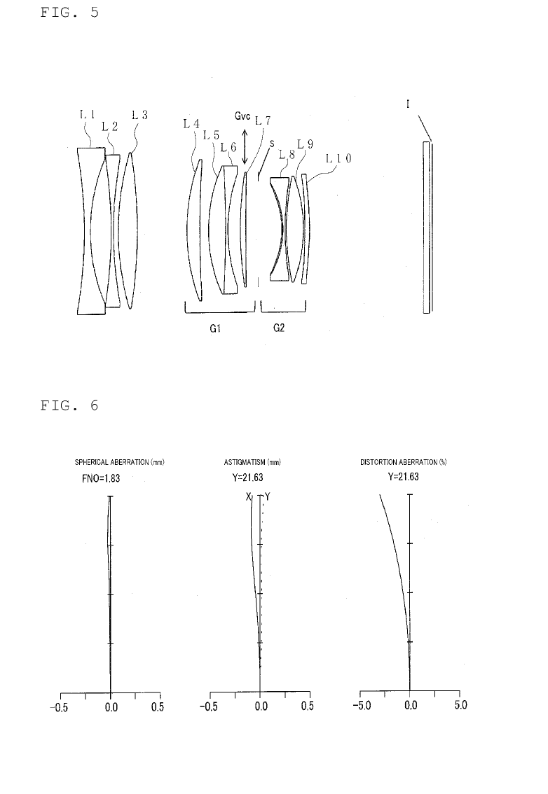

FIG. 5 is a lens cross-sectional view showing a configuration of a fixed focus lens which is an optical system of Example 3 according to the present invention. The fixed focus lens is configured with a fixed group having a negative refractive power, a first movement group G1 having a positive refractive power and a second movement group G2 having a positive refractive power in that order from the object side.

The fixed group is configured with a biconcave lens L1 having a negative refractive power, a biconcave lens L2 having a negative refractive power and a biconvex lens L3 having a positive refractive power in that order from the object side. The first movement group G1 is configured with a first positive lens L4 having a strong curvature on the object side and having a positive refractive power, a cemented lens composed of a lens L5 having a positive refractive power and a lens L6 having a negative refractive power, and a second positive lens L7 having a strong curvature on the object side and having a positive refractive power in that order from the object side. The second movement group G2 is configured with a biconcave lens L8 having an aspheric surface on the object side and having a negative refractive power, a biconvex lens L9 having a positive refractive power, and a lens L10 having aspheric surfaces on both surfaces and having a positive refractive power in that order from the object side.

At the time of focusing from an object at infinity to a short-distance object, the fixed group is fixed relative to the image plane, the first movement group G1 moves to the object side, and the second movement group G2 moves to the object side so that the distance between the second movement group G2 and the first movement group G1 decreases. Further, the second positive lens L7 in the first movement group G1 is an image stabilization group Gvc, and the second positive lens L7 moves in a direction vertical to the optical axis at the time of image stabilization.

### (2) Typical Numerical Values

Next, typical numerical values in which specific numerical values of the fixed focus lens are applied will be described. (Table 3-1) shows lens data of the fixed focus lens; (Table 3-2) shows aspheric coefficients and conic constants of aspheric surfaces; (Table 3-3) shows variable intervals of lens surfaces on the optical axis; and (Table 3-4) shows the focal length (f), larger aperture ratio (Fno) and half image viewing angle (W) of the fixed focus lens. FIG. 6 shows longitudinal aberration diagrams of the fixed focus lens at the time of infinite-distance focusing.

TABLE 3-1

| No. | R | D | Nd | νd | ΔPgf |
|---|---|---|---|---|---|
| 1 | −99.56 | 2.00 | 1.52 | 52.15 | |
| 2 | 40.59 | 6.93 | | | |
| 3 | −102.85 | 0.80 | 1.49 | 70.44 | |
| 4 | 85.83 | 1.62 | | | |
| 5 | 60.13 | 6.32 | 1.75 | 49.22 | |
| 6 | −105.41 | D6 | | | |
| 7 | 44.06 | 4.32 | 1.84 | 42.72 | |
| 8 | 229.78 | 2.88 | | | |
| 9 | 34.33 | 5.66 | 1.50 | 81.61 | 0.038 |
| 10 | −258.79 | 0.80 | 1.72 | 29.50 | |
| 11 | 37.05 | 4.13 | | | |
| 12 | 77.44 | 1.80 | 1.62 | 63.39 | 0.006 |
| 13 | 655.64 | 4.15 | | | |
| STOP | INF | D14 | | | |
| 15* | −17.33 | 0.30 | 1.54 | 41.21 | |
| 16 | −20.41 | 0.80 | 1.65 | 33.84 | |
| 17 | 68.59 | 0.40 | | | |
| 18 | 54.10 | 5.67 | 1.84 | 42.72 | |
| 19 | −32.53 | 0.40 | | | |
| 20* | −333.33 | 1.57 | 1.81 | 45.45 | |
| 21* | −78.93 | D21 | | | |
| 22 | INF | 2.00 | 1.52 | 64.20 | |
| 23 | INF | 1.00 | | | |

### Example 4

### (1) Configuration of Optical System

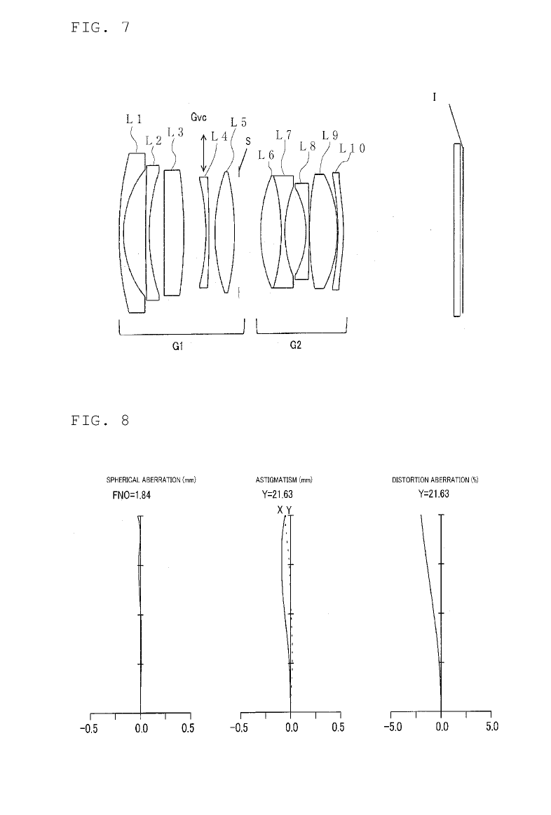

FIG. 7 is a lens cross-sectional view showing a configuration of a fixed focus lens which is an optical system of Example 4 according to the present invention. The fixed focus lens is configured with a first movement group G1 having a positive refractive power and a second movement group G2 having a positive refractive power in that order from the object side.

The first movement group G1 is configured with a meniscus lens L1 having a strong curvature on the image side and having a negative refractive power, a meniscus lens L2 having a strong curvature on the image side and having a negative refractive power, a lens L3 having a positive refractive power, a meniscus lens L4 having a strong curvature on the object side and having a negative refractive power, and a biconvex lens L5 having a positive refractive power in that order from the object side. The second movement group G2 is configured with a cemented lens composed of a lens L6 having a positive refractive power and a lens L7 having a negative refractive power, a meniscus lens L8 having a strong curvature on the object side and having a negative refractive power, a biconvex lens L9 having a positive refractive power, and a lens L10 having aspheric surfaces on both surfaces and having a positive refractive power in that order from the object side.

At the time of focusing from an object at infinity to a short-distance object, the fixed group is fixed relative to the image plane, the first movement group G1 moves to the object side, and the second movement group G2 moves to the object side so that the distance between the second movement group G2 and the first movement group G1 decreases. Further, the meniscus lens L4 having a strong curvature on the object side and having a negative refractive power in the first movement group G1 is an image stabilization group Gvc, and the meniscus lens L4 moves in a direction vertical to the optical axis at the time of image stabilization.

### (2) Typical Numerical Values

Next, typical numerical values in which specific numerical values of the fixed focus lens are applied will be described. (Table 4-1) shows lens data of the fixed focus lens; (Table 4-2) shows aspheric coefficients and conic constants of aspheric surfaces; (Table 4-3) shows variable intervals of lens surfaces on the optical axis; and (Table 4-4) shows the focal length (f), larger aperture ratio (Fno) and half image viewing angle (W) of the fixed focus lens. FIG. 8 shows longitudinal aberration diagrams of the fixed focus lens at the time of infinite-distance focusing.

TABLE 4-1

| No. | R | D | Nd | νd | ΔPgf |
|---|---|---|---|---|---|
| 1 | 67.42 | 1.50 | 1.49 | 70.44 | |
| 2 | 23.30 | 7.35 | | | |
| 3 | 469.02 | 1.20 | 1.44 | 95.10 | |
| 4 | 42.40 | 4.98 | | | |
| 5 | −3757.23 | 6.49 | 1.88 | 40.14 | |
| 6 | −99.65 | 7.31 | | | |
| 7 | −47.10 | 1.00 | 1.49 | 70.44 | |
| 8 | −244.00 | 2.00 | | | |
| 9 | 40.64 | 6.46 | 1.50 | 81.61 | 0.038 |
| 10 | −58.38 | 1.52 | | | |
| STOP P | INF | D11 | | | |
| 12 | 32.39 | 6.85 | 1.80 | 46.50 | |
| 13 | −44.47 | 1.22 | 1.62 | 36.30 | |
| 14 | 26.73 | 6.97 | | | |
| 15 | −20.54 | 1.00 | 1.69 | 31.16 | |
| 16 | −481.83 | 0.15 | | | |
| 17 | 65.65 | 9.24 | 1.73 | 54.67 | |
| 18 | −27.76 | 0.20 | | | |
| 19* | −58.10 | 1.80 | 1.85 | 40.10 | |
| 20* | −47.37 | D20 | | | |
| 21 | INF | 2.00 | 1.52 | 64.20 | |
| 22 | INF | 1.00 | | | |

### Example 5

### (1) Configuration of Optical System

FIG. 9 is a lens cross-sectional view showing a configuration of a fixed focus lens which is an optical system of Example 5 according to the present invention. The fixed focus lens is configured with a fixed group having a negative refractive power, a first movement group G1 having a positive refractive power and a second movement group G2 having a positive refractive power in that order from the object side.

The fixed group is configured with a biconcave lens L1 having a negative refractive power, and a cemented lens composed of a lens L2 having a negative refractive power and a lens L3 having a positive refractive power in that order from the object side. The first movement group G1 is configured with a biconvex lens L4 having a positive refractive power, and a cemented lens composed of a lens L5 having a negative refractive power and a lens L6 having a positive refractive power in that order from the object side. The second movement group G2 is configured with a cemented lens composed of a lens L7 having a negative refractive power and a lens L8 having a positive refractive power, a biconvex lens L9 having a positive refractive power, a biconcave lens L10 having a negative refractive power and a lens L11 having an aspheric surface on the image size and having a positive refractive power in that order from the object side.

At the time of focusing from an object at infinity to a short-distance object, the fixed group is fixed relative to the image plane, the first movement group G1 moves to the object side, and the second movement group G2 moves to the object side so that the distance between the second movement group G2 and the first movement group G1 decreases. Further, the cemented lens in the first movement group G1 is an image stabilization group Gvc, and the cemented lens moves in a direction vertical to the optical axis at the time of image stabilization.

### (2) Typical Numerical Values

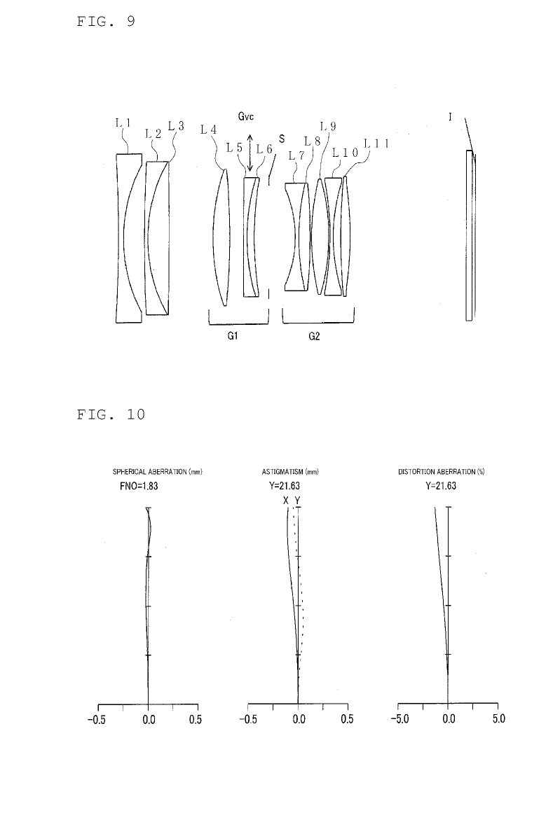

Next, typical numerical values in which specific numerical values of the fixed focus lens are applied will be described. (Table 5-1) shows lens data of the fixed focus lens; (Table 5-2) shows aspheric coefficients and conic constants of aspheric surfaces; (Table 5-3) shows variable intervals of lens surfaces on the optical axis; and (Table 5-4) shows the focal length (f), larger aperture ratio (Fno) and half image viewing angle (W) of the fixed focus lens. FIG. 10 shows longitudinal aberration diagrams of the fixed focus lens at the time of infinite-distance focusing.

TABLE 5-1

| No. | R | D | Nd | νd | ΔPgf |
|---|---|---|---|---|---|
| 1* | −299.42 | 1.70 | 1.63 | 33.05 | |
| 2* | 34.94 | 7.08 | | | |
| 3 | 335.00 | 1.10 | 1.45 | 83.13 | |
| 4 | 34.90 | 7.13 | 1.84 | 42.72 | |
| 5 | −1592.31 | D5 | | | |
| 6 | 47.08 | 5.63 | 1.63 | 61.10 | 0.006 |
| 7 | −156.10 | 4.64 | | | |
| 8 | 1393.07 | 1.20 | 1.58 | 38.34 | |
| 9 | 44.32 | 2.42 | 1.86 | 23.78 | |
| 10 | 73.95 | 4.95 | | | |
| STOP | INF | D11 | | | |
| 12 | −26.34 | 1.20 | 1.75 | 26.70 | |
| 13 | 50.90 | 3.80 | 1.84 | 42.72 | |
| 14 | −117.73 | 0.50 | | | |
| 15 | 52.83 | 5.78 | 1.84 | 42.72 | |
| 16 | −45.54 | 0.40 | | | |
| 17 | −63.37 | 1.10 | 1.59 | 36.85 | |
| 18 | 39.63 | 2.49 | | | |
| 19 | 130.89 | 3.23 | 1.84 | 42.72 | |
| 20* | −63.61 | D20 | | | |
| 21 | INF | 2.00 | 1.52 | 64.20 | |
| 22 | INF | 1.00 | | | |

### Example 6

### (1) Configuration of Optical System

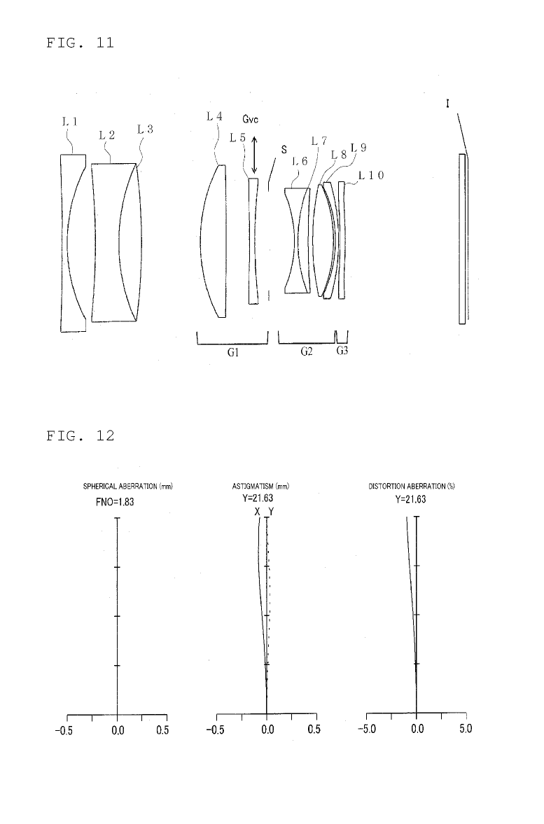

FIG. 11 is a lens cross-sectional view showing a configuration of a fixed focus lens which is an optical system of Example 6 according to the present invention. The fixed focus lens is configured with a fixed group having a negative refractive power, a first movement group G1 having a positive refractive power, a second movement group G2 having a positive refractive power and a third movement group G3 having a positive refractive power in that order from the object side.

The fixed group is configured with a biconcave lens L1 having a negative refractive power, and a cemented lens composed of a lens L2 having a negative refractive power and a lens L3 having a positive refractive power in that order from the object side. The first movement group G1 is configured with a biconvex lens L4 having a positive refractive power and a biconcave lens L5 having aspheric surfaces on both surfaces and having a negative refractive power in that order from the object side. The second movement group G2 is configured with a cemented lens composed of a lens L6 having a negative refractive power and a lens L7 having a positive refractive power, a biconvex lens L8 having a positive refractive power, and a meniscus lens L9 having a negative refractive power in that order from the object side. The third movement group G3 is configured with a lens L10 having aspheric surfaces on both surfaces and having a positive refractive power.

At the time of focusing from an object at infinity to a short-distance object, the fixed group is fixed relative to the image plane, the first movement group G1 moves to the object side; the second movement group G2 moves to the object side so that the distance between the second movement group G2 and the first movement group G1 decreases; and the third movement group G3 moves to the object side so that the distance between the third movement group G3 and the second movement group G2 increases. Further, the biconcave lens L5 in the first movement group G1 is an image stabilization group Gvc, and the biconcave lens L5 moves in a direction vertical to the optical axis at the time of image stabilization.

### (2) Typical Numerical Values

Next, typical numerical values in which specific numerical values of the fixed focus lens are applied will be described. (Table 6-1) shows lens data of the fixed focus lens; (Table 6-2) shows aspheric coefficients and conic constants of aspheric surfaces; (Table 6-3) shows variable intervals of lens surfaces on the optical axis; and (Table 6-4) shows the focal length (f), larger aperture ratio (Fno) and half image viewing angle (W) of the fixed focus lens. FIG. 12 shows longitudinal aberration diagrams of the fixed focus lens at the time of infinite-distance focusing.

TABLE 6-1

| No. | R | D | Nd | νd | ΔPgf |
|---|---|---|---|---|---|
| 1 | −451.75 | 1.70 | 1.52 | 64.15 | |
| 2 | 36.34 | 9.65 | | | |
| 3 | −157.47 | 8.00 | 1.59 | 35.31 | |
| 4 | 40.85 | 7.75 | 1.83 | 42.72 | |
| 5 | −127.28 | D5 | | | |
| 6 | 36.52 | 8.84 | 1.60 | 67.73 | 0.012 |
| 7 | −933.69 | 8.00 | 0.00 | | |
| 8* | −374.52 | 1.80 | 1.50 | 81.56 | |
| 9* | 115.53 | 4.73 | 0.00 | | |
| 10 | INF | D10 | 0.00 | | |
| STOP | −26.71 | 1.20 | 1.70 | 30.13 | |
| 12 | 31.91 | 3.53 | 1.83 | 42.72 | |
| 13 | 154.46 | 1.52 | 0.00 | | |
| 14 | 55.07 | 7.09 | 1.83 | 42.72 | |
| 15 | −29.78 | 0.66 | 0.00 | | |
| 16 | −27.40 | 1.10 | 1.67 | 32.10 | |
| 17 | −45.06 | D17 | 0.00 | | |
| 18* | −93.22 | 1.80 | 1.70 | 55.46 | |
| 19* | −74.92 | D19 | 0.00 | | |
| 20 | INF | 2.00 | 1.52 | 64.20 | |
| 21 | INF | 1.00 | | | |

Table 7 shows numerical values of the expressions (1) to (7) and numerical values of f1/f2 in “Typical numerical values” above.

TABLE 7

| | EXPRESSION | EXPRESSION | EXPRESSION | EXPRESSION | EXPRESSION | EXPRESSION | EXPRESSION | |
|---|---|---|---|---|---|---|---|---|
| | (1) | (2) | (3) | (4) | (5) | (6) | (7) | f1/f2 |
| EXAMPLE1 | 0.829 | 1.346 | 2.246 | 1.794 | 0.615 | 0.006 | 65.25 | 1.669 |
| EXAMPLE2 | 0.809 | 1.395 | 2.187 | 2.190 | 0.508 | 0.012 | 67.73 | 1.568 |
| EXAMPLE3 | 0.870 | 2.729 | 1.210 | 3.065 | 0.355 | 0.038 | 81.61 | 0.443 |
| EXAMPLE4 | 0.661 | 1.698 | 4.611 | 3.500 | 0.399 | 0.038 | 81.61 | 2.716 |
| EXAMPLE5 | 0.829 | 1.592 | 1.610 | 4.528 | 0.237 | 0.006 | 61.10 | 1.011 |
| EXAMPLE6 | 0.830 | 2.082 | 1.721 | 3.846 | 0.286 | 0.012 | 67.73 | 0.827 |

An optical system according to the present invention includes: a first movement group moving along an optical axis direction at the time of focusing from an object at infinity to a short-distance object; and a second movement group provided on an image side of the first movement group and moving to an object side by an amount of movement different from an amount of movement of the first movement group at the time of focusing from the object at infinity to the short-distance object; the optical system further including an image stabilization group in a movement group among movement groups including the first movement group and the second movement group; and the optical system satisfying an expression (1) below:

m1/m2<1.0 (1)

wherein m1 indicates the amount of movement of the first movement group from an infinite-distance focused state to a shortest-distance focused state; m2 indicates the amount of movement of the second movement group from the infinite-distance focused state to the shortest-distance focused state; and, as for the amounts of movement, a negative sign is given to movement to the object side, and a positive sign is given to movement to the image plane side.

It is preferable that the optical system according to one embodiment of the present invention satisfies an expression (2) below.

0.80<f2/f<10.00 (2)

wherein f2 indicates a focal length of the second movement group, and f indicates a focal length of the entire optical system.

In the optical system according to one embodiment of the present invention, it is preferable that the image stabilization group is configured with one single lens component.

It is preferable that the optical system according to one embodiment of the present invention satisfies an expression (3) below.

1.10<f1/f<6.50 (3)

wherein f1 indicates a focal length of the first movement group, and f indicates the focal length of the entire optical system.

It is preferable that the optical system according to one embodiment of the present invention satisfies an expression (4) below.

1.25<|fvc|/f<8.00 (4)

wherein fvc indicates a focal length of the image stabilization group, and f indicates the focal length of the entire optical system.

It is preferable that the optical system according to one embodiment of the present invention satisfies an expression (5) below.

0.1<|(1−vc)r|<0.7 (5)

wherein vc is a lateral magnification of the image stabilization group at the time of infinite-distance focusing, and r is a combined lateral magnification of a lens arranged on an image side of the image stabilization group at the time of infinite-distance focusing.

In the optical system according to one embodiment of the present invention, it is preferable that an object-side surface of a lens arranged on the most object side in the first movement group is in a shape convex on the object side.

In the optical system according to one embodiment of the present invention, it is preferable that the image stabilization group is arranged in the first movement group.

In the optical system according to one embodiment of the present invention, it is preferable that each of the first movement group and the second movement group moves to the object side at the time of focusing from the object at infinity to the short-distance object.

In the optical system according to one embodiment of the present invention, it is preferable that any one lens group among lens groups constituting the optical system has a positive refractive power, and the lens group having the positive refractive power has at least one lens having a positive refractive power that satisfies expressions (6) and (7) below:

PgF0.006 (6)

d61.0 (7)

wherein PgF indicates deviation of a partial dispersion ratio from a reference line when a line passing through coordinates of C7 (partial dispersion ratio: 0.5393, d: 60.49) and coordinates of F2 (partial dispersion ratio: 0.5829, d: 36.30) is assumed to be the reference line, the coordinates being indicated by partial dispersion ratio and d; and d is an abbe number on a d-line.

An image pickup apparatus according to one embodiment of the present invention includes: the optical system described above; and an image sensor provided on the image side of the optical system, the image sensor converting an optical image formed by the optical system to an electrical signal.

According to one embodiment of the present invention, it is possible to achieve reduction in weight and size of the entire optical system equipped with an image stabilization group and provide the optical system which is excellent in image formation performance, from an infinite distance to a close distance, even at the time of image stabilization.

According to the present invention, it is possible to achieve reduction in weight and size of the entire optical system equipped with an image stabilization group and provide the optical system which is excellent in image formation performance, from an infinite distance to a close distance, even at the time of image stabilization.

### REFERENCE SIGNS LIST

G1 first movement group
G2 second movement group
Gvc image stabilization group
S stop
I image plane

What is claimed is:

1. An optical system comprising:
a first movement group moving along an optical axis direction at a time of focusing from an object at infinity to a short-distance object; and
a second movement group provided on an image side of the first movement group and moving to an object side by an amount of movement different from an amount of movement of the first movement group at the time of focusing from the object at infinity to the short-distance object;
the optical system further comprising an image stabilization group in a movement group among movement groups including the first movement group and the second group; and
the optical system satisfying an expression (1) below:
m1/m2<1.0 (1)
wherein m1 indicates an amount of movement of the first movement group from an infinite-distance focused state to a shortest-distance focused state; m2 indicates an amount of movement of the second movement group from the infinite-distance focused state to the shortest-distance focused state; and, as for the amounts of movement, a negative sign is given to movement to the object side, and a positive sign is given to movement to the image plane side.

2. The optical system according to claim 1, satisfying an expression (2) below:
0.80<f2/f<10.00 (2)
wherein f2 indicates a focal length of the second movement group, and f indicates a focal length of the entire optical system.

3. The optical system according to claim 1, wherein the image stabilization group is configured with one single lens component.

4. The optical system according to claim 1, satisfying an expression (3) below:
1.10<f1/f<6.50 (3)
wherein f1 indicates a focal length of the first movement group, and f indicates a focal length of the entire optical system.

5. The optical system according to claim 1, satisfying an expression (4) below:
1.25<|fvc|/f<8.00 (4)
wherein fvc indicates a focal length of the image stabilization group, and f indicates a focal length of the entire optical system.

6. The optical system according to claim 1, satisfying an expression (5) below:
0.1<|(1−vc)r|<0.7 (5)
wherein vc is a lateral magnification of the image stabilization group at the time of infinite-distance focusing, and r is a combined lateral magnification of a lens arranged on an image side of the image stabilization group at the time of infinite-distance focusing.

7. The optical system according to claim 1, wherein an object-side surface of a lens arranged on a most object side in the first movement group is in a shape convex on the object side.

8. The optical system according to claim 1, wherein the image stabilization group is arranged in the first movement group.

9. The optical system according to claim 1, wherein each of the first movement group and the second movement group moves to the object side at the time of focusing from the object at infinity to the short-distance object.

10. The optical system according to claim 1, wherein any one lens group among lens groups constituting the optical system has a positive refractive power, and the lens group having the positive refractive power has at least one lens having a positive refractive power that satisfies expressions (6) and (7) below:
PgF0.006 (6)
d61.0 (7)
wherein PgF indicates deviation of a partial dispersion ratio from a reference line when a line passing through coordinates of C7 (partial dispersion ratio: 0.5393, d: 60.49) and coordinates of F2 (partial dispersion ratio: 0.5829, d: 36.30) is assumed to be the reference line, the coordinates being indicated by partial dispersion ratio and d; and d is an abbe number on a d-line.

11. An image pickup apparatus comprising:
the optical system according to claim 1; and
an image sensor provided on the image side of the optical system, the image sensor converting an optical image formed by the optical system to an electrical signal.
